(19) United States
(12) Patent Application Publication
(10) Pub. No.: US 2016/0111732 A1
(43) Pub. Date: Apr. 21, 2016

(54) FUEL CELL

(71) Applicant: PLANSEE COMPOSITE MATERIALS GMBH, Lechbruck am See (DE)

(72) Inventors: Thomas Franco, Kempten (DE); Markus Haydn, Reutte (AT); Markus Koegl, Vils (AT); Matthias Ruettinger, Reutte (AT); Gebhard Zobl, Schattwald (AT)

(21) Appl. No.: 14/893,163

(22) PCT Filed: May 7, 2014
(86) PCT No.: PCT/EP2014/001219

§ 371 Date: Nov. 23, 2015

(30) Foreign Application Priority Data
May 21, 2013 (DE) 10 2013 008 473.3

(51) Int. Cl. H01M 8/02; B23K 26/00; B23K 26/354; B22F 3/02

(52) U.S. Cl. CPC H01M 8/0232; H01M 8/0273; B22F 3/02; B23K 26/0081; B23K 26/354; H01M 2008/1293

(57) ABSTRACT

A plate-shaped, porous, carrier substrate produced by powder metallurgy for a metal-supported electrochemical functional device, includes a marginal region and a central region with a surface configured to receive a layer stack with electrochemically active layers on a cell-facing side of the carrier substrate. A surface section of the marginal region has a melt phase of the carrier substrate material on the cell-facing side of the carrier substrate. At least sections of a region located beneath the surface section having the melt phase have a higher porosity than the surface section disposed above them and having the melt phase.

The invention relates to a carrier substrate for a metal-supported electrochemical functional device, to a production method for a carrier substrate of this kind, and to the application thereof in fuel cells.

One possible field of application for the carrier substrate of the invention is with high-temperature fuel cells (SOFCs; solid oxide fuel cells), which are operated typically at a temperature of approximately 600-1000° C. In the basic configuration, the electrochemically active cell of an SOFC comprises a gas-impervious solid electrolyte, which is arranged between a gas-pervious anode and gas-pervious cathode. This solid electrolyte is usually made from a solid ceramic material of metal oxide, which is a conductor of oxygen ions but not of electrons. In terms of design, the planar SOFC system (also called flat cell design) is presently the preferred cell design worldwide. With this design, individual electrochemically active cells are arranged to form a stack, and are joined by metallic components, referred to as interconnectors or bipolar plates. With SOFC systems, there are a variety of embodiments known from the prior art, and briefly outlined below. With a first variant, technically the most advanced and already in the market introduction phase, the electrolyte is the mechanically supporting cell component (“Electrolyte Supported Cell”, ESC). The layer thickness of the electrolyte here is relatively large, approximately 100-150 μm, and consists usually of zirconium dioxide stabilized with yttrium oxide (YSZ) or with scandium oxide (ScSZ). In order to achieve sufficient ion conductivity on the part of the electrolyte, these fuel cells have to be operated at a relatively high temperature of approximately 850-1000° C. This high operating temperature imposes exacting requirements on the materials employed.

Efforts to achieve a lower operating temperature led consequently to the development of different thin-layer systems. These include anode-supported and cathode-supported cell SOFC systems, in which a relatively thick (at least approximately 200 μm) mechanically supporting ceramic anode or cathode substrate is joined to a thin, electrochemically active functional cathode or anode layer, respectively. Since the electrolyte layer no longer has to perform a mechanical support role, it can be made relatively thin and the operating temperature can be reduced accordingly on the basis of the lower ohmic resistance.

As well as these purely ceramic systems, a more recent development generation has seen the emergence of SOFC thin-layer systems based on a metallic carrier substrate, known as metal-supported SOFCs (“metal-supported cells”, MSC). These metallo-ceramic composite systems display advantages over purely ceramic thin-layer systems in terms of thermal and redox cyclability and also mechanical stability, and are also able, on the basis of their thin-layer electrolyte, to be operated at an even lower temperature of approximately 600° to 800° C. On account of their specific advantages, they are suitable in particular for mobile applications, such as for the electrical supply of personal motor vehicles or utility vehicles (APU—auxiliary power units), for example. In comparison to fully ceramic SOFC systems, the metallo-ceramic MSC systems are notable for significantly reduced materials costs and also for new possibilities in stack integration, such as by soldering or welding operations, for example. An exemplary MSC consists of a porous metallic carrier substrate whose porosity and thickness of approximately 1 mm make it gas-permeable; arranged on this substrate is a ceramic composite structure, with a thickness of 60-70 μm, this being the layer arrangement that is actually electrochemically active, with the electrolyte and the electrodes. The anode is typically facing the carrier substrate, and is closer to the metal substrate than the cathode in the sequence of the layer arrangement. In the operation of an SOFC, the anode is supplied with fuel (for example hydrogen or conventional hydrocarbons, such as methane, natural gas, biogas, etc.), which is oxidized there catalytically with emission of electrons. The electrons are diverted from the fuel cell and flow via an electrochemical consumer to the cathode. At the cathode, an oxidizing agent (oxygen or air, for example) is reduced by acceptance of the electrons. The electrical circuit is completed by the oxygen ions flowing to the anode via the electrolyte, and reacting with the fuel at the corresponding interfaces.

A challenging problem affecting the development of fuel cells is the reliable separation between the two process gas spaces—that is, the separation of the fuel supplied to the anode from the oxidizing agent supplied to the cathode. In this respect, the MSC promises a great advantage, since sealing and stack designs with long-term stability can be realized in an inexpensive way by means of welding or metallic soldering operations. One exemplary variant of a fuel cell unit is presented in WO 2008/138824. With this fuel cell unit, a gas-permeable substrate is mounted with the electrochemically active layers into a relatively complex frame device, with a window-like opening, and is soldered. On account of its complexity, however, this frame device is very difficult to realize.

EP 1 278 259 discloses a fuel cell unit where the gas-permeable substrate, with the electrochemically active layers, is mounted in a metal frame with a window-like opening, into which further openings for the supply and removal of the fuel gas are provided. A gas-impervious gas space is created by welding the metal substrate, which is pressed at the margin, into this metal frame, and then connecting it in a gas-impervious way to a contact plate which acts as an interconnector. For the reliable separation of the two process gas spaces, the gas-impervious electrolyte is drawn via the weld seam after joining. An onward development is the variant produced by powder metallurgy, and described in DE 10 2007 034 967, where the metal frame and the metallic carrier substrate are configured as an integral component. In this case, the metallic carrier substrate is subjected to gas-impervious compression in the marginal region, and the fuel gas and exhaust gas openings needed for supply of fuel gas and removal of waste gas, respectively, are integrated in the marginal region of the carrier substrate. A gas-impervious gas space is brought about by subjecting the metal substrate to gas-impervious compression on the marginal region, after a sintering operation, with the aid of a press and of pressing dies shaped accordingly, and is then welded in the marginal region with a contact plate which acts as an interconnector. A disadvantage is that gas-impervious sealing of the marginal region is extremely difficult to achieve, since the powder-metallurgical alloys typically used for the carrier substrate, which meet the high materials requirements in terms of operation of an SOFC, are comparatively brittle and difficult to form. For example, for the gas-impervious forming of a carrier substrate made from the Fe-Cr alloy in DE 10 2007 034 967, pressing forces in the order of magnitude of more than 1200 tonnes are required. This gives rise not only to high capital costs for a press with a corresponding power capability, but also, furthermore, to high operating costs, relatively high wear on the pressing tool, and a higher maintenance effort for the press.

Another alternative approach for an MSC stack which can be integrated with welding technology is based on a centrally perforated metal sheet with an impervious marginal region, as a metallic carrier substrate (WO 0235628).

A disadvantage with this approach is that the supply of the fuel gas to the electrode, which for reasons of efficiency is to take place very homogeneously over the area of the electrode, is achieved only in an unsatisfactory way.

It is an object of the present invention to provide a carrier substrate of the above-specified kind, which when used in an electrochemical functional device, more particularly in a high-temperature fuel cell, allows the two process gas spaces to be separated reliably, easily and inexpensively.

This object is achieved by the subject matter and methods having the features according to the independent claims.

According to one exemplary embodiment of the present invention, the proposal is made in accordance with the invention, in the case of a plate-shaped, metallic carrier substrate produced by powder metallurgy and having the features of the preamble of claim 1, that a surface section having a melt phase of the carrier substrate material be formed in a marginal region of the carrier substrate, on the cell-facing side of the carrier substrate. In accordance with the invention, the region located beneath the surface section having the melt phase has sections at least that are of higher porosity than the surface section arranged above them and having the melt phase.

“Cell-facing” here denotes the side of the carrier substrate to which a layer stack with electrochemically active layers is applied in a subsequent operating step, in a central region of the porous carrier substrate. Normally, the anode is arranged on the carrier substrate, the gas-impervious electrolyte that conducts oxygen ions is arranged on the anode, and the cathode is arranged on the electrolyte.

However, the sequence of electrode layers may also be reversed, and the layer stack may also have additional functional layers; for example, there may be a diffusion barrier layer provided between carrier substrate and the first electrode layer.

“Gas-impervious” means that the leakage rate with sufficient imperviosity to gas is <10⁻³ mbar l/cm² s on a standard basis (measured under air by the pressure increase method (Dr. Wiesner, Remscheid, type: Integra DDV) with a pressure difference dp=100 mbar).

The solution provided by the invention is based on the finding that it is not necessary, as proposed in the prior art in DE 10 2007 034 967, to subject the entire marginal region of the carrier substrate to gas-impervious compression, but instead that the originally gas-pervious porous marginal region or precompacted porous marginal region can be made impervious to gas by means of a surface aftertreatment step that leads to the formation of a melt phase from the material of the carrier substrate in a near-surface region. A surface aftertreatment step of this kind can be accomplished by local, superficial melting of the porous carrier substrate material, i.e. brief local heating to a temperature higher than the melting temperature, and can be achieved by means of mechanical, thermal or chemical method steps, as for example by means of abrading, blasting or by application of laser beams, electron beams or ion beams. A surface section having the melting phase is obtained preferably by causing bundled beams of high-energy photons, electrons, ions or other suitable focusable energy sources to act on the surface of the marginal region down to a particular depth. As a result of the local melting and rapid cooling after melting, this region develops an altered metallic microstructure, with a negligible or extremely low residual porosity.

The metal carrier substrate of the invention is produced by powder metallurgy and consists preferably of an iron-chromium alloy. The substrate may be produced as in AT 008 975 U1, and may therefore consist of an Fe-based alloy with Fe >50 weight % and 15 to 35 weight % Cr; 0.01 to 2 weight % of one or more elements from the group consisting of Ti, Zr, Hf, Mn, Y, Sc and rare earth metals; 0 to 10 weight % of Mo and/or Al; 0 to 5 weight % of one or more metals from the group consisting of Ni, W, Nb and Ta; 0.1 to 1 weight % of 0; remainder Fe and impurities, with at least one metal from the group consisting of Y, Sc and rare earth metals, and at least one metal from the group consisting of Cr, Ti, Al and Mn, forming a mixed oxide. The substrate is formed using, preferably, a powder fraction with a particle size <150 μm, more particularly <100 μm. In this way the surface roughness can be kept sufficiently low to ensure the possibility of effective application of functional layers. After the sintering operation, the porous substrate has a porosity of preferably 20% to 60%, more particularly 40% to 50%. The thickness of the substrate may be preferably 0.3 to 1.5 mm. The substrate is preferably compacted subsequently in the marginal region or in parts of the marginal region; the marginal-region compaction may be accomplished by uniaxial compression or by profiled rolls. In this case the marginal region has a higher density and a lower porosity than the central region. During the compacting operation, the aim is preferably for a continuous transition between the substrate region and the denser marginal region, in order to prevent stresses in the substrate. This compacting operation is advantageous so that, in the subsequent surface-working step, the local change in volume is not too pronounced and does not give rise to warping or distortions in the microstructure of the carrier substrate. For the marginal region, a porosity of less than 20%, preferably a porosity of 4% to 12%, has emerged as being particularly advantageous. This residual porosity does not yet guarantee imperviosity to gas, since after this compacting operation the marginal region can have surface pores with a dimensional extent of up to 50 μm.

As a next step, at least part of the cell-facing surface of the marginal region undergoes a surface treatment step, leading to the formation of a melt phase of the material of the carrier substrate in a surface section. The surface section having the melt phase extends generally, running round the outer periphery of the central region of the carrier substrate, up to the outer edges of the marginal region, at which the carrier substrate is joined in a gas-impervious manner, by means of a weld seam running round, for example, to a contact plate, frequently also referred to as an interconnector. As a result, a planar barrier is formed along the surface of the carrier substrate, reaching from the central region of the carrier substrate, at which the layer stack with the gas-impervious electrolyte is applied, to the weld seam, which forms a gas-impervious seal with respect to the interconnector.

A surface treatment step of this kind, leading to the superficial melting, may be accomplished by means of mechanical, thermal or chemical method steps, as for example by means of abrading or blasting or by causing bundled beams of high-energy photons, electrons, ions or other suitable focusable energy sources to act on the surface of the marginal region.

As a result of the local, superficial melting and rapid cooling, an altered metallic microstructure is formed; the residual porosity is extremely small. Melting may take place a single time or else a number of times in succession. The depth of this melting should be adapted to the gas imperviosity requirement of the near-surface region, with a melting depth of at least 1 μm, more particularly 15 μm to 150 μm, more preferably 15 μm to 60 μm, having emerged as being suitable. The surface section having the melt phase therefore extends from the surface into the carrier substrate for at least 1 μm, more particularly 15 μm to 150 μm, more preferably 15 μm to 60 μm, as measured from the surface of the carrier substrate.

As well as the melt phase, the surface section having the melt phase may also contain other phases, examples being amorphous structures. With particular preference, the surface section having the melt phase is formed wholly of the melt phase of the carrier substrate material. In the marginal region, the melting operation results in a very smooth surface of low roughness. This allows functional layers such as an electrolyte layer to be readily applied, such an electrolyte layer being applied optionally, as described below, for the better sealing of the process gas spaces over part of the marginal region as well.

In order to reduce contraction of the carrier substrate marginal region resulting from the melting operation, a powder or a powder mixture of the carrier substrate starting material of small particle size may be applied before the melting operation, in order to fill the open superficial pores. This is followed by the superficial melting operation. This step enhances the dimensional stability of the carrier substrate shape.

It is a particular advantage that the marginal region of the carrier substrate need no longer be subjected to gas-impervious compression, as in accordance with the prior art, for example DE 10 2007 034 967, but instead can have a density and porosity with which imperviosity to fluid is not necessarily the case. Consequently, considerable cost savings can be achieved in production.

The carrier substrate of the invention is suitable for an electrochemical functional device, preferably for a solid electrolyte fuel cell, which can have an operating temperature of up to 1000° C. Alternatively, for example, the substrate may be used in membrane technology, for electrochemical gas separation.

As part of the development of MSC systems, a variety of approaches have been pursued, in which various carrier substrate arrangements with different depths of integration are employed.

In accordance with the invention, for a first variant, a carrier substrate arrangement is proposed which has a carrier substrate of the invention, which is encased by a frame device made from electrically conductive material, with the frame device electrically contacting the carrier substrate and having at least one gas passage. These gas passages serve for the supply and removal of the process gas, for example the fuel gas. A gas-impervious gas space is created by connecting the carrier substrate arrangement in a gas-impervious manner to a contact plate which acts as an interconnector. Through the frame device and the interconnector, therefore, a kind of housing is formed, and in this way a fluid-impervious process gas space is realized. The surface section of the carrier substrate that has the melt phase extends from the outer periphery of the central region to the outer edges of the marginal region, or to the point at which the carrier substrate is joined to the frame device by welding or soldering.

In a second embodiment, the carrier substrate and the frame device are configured as an integral component. Gas passages are formed in the marginal region, on opposite sides of the plate-shaped carrier substrate, by means of punching, cutting, embossing or similar techniques. These passages are intended for the supply and removal of the process gas, particularly the fuel gas. In the marginal region which has gas passages, the carrier substrate is aftertreated by superficial melting. The surface-aftertreated region here is selected so as to form a coherent section which surrounds at least part of the gas passages, preferably those passages which are intended for the supply and withdrawal of the process gases (fuel gases and oxide gases). The surface section having the melting phase is a coherent section over at least part of the marginal region, and extends, running around the outer periphery of the central region, on the one hand to the edges of the enclosed gas passages, and on the other hand to the outer edges of the marginal region or to the point at which the carrier substrate is joined to the interconnector plate by welding or soldering. In order to ensure imperviosity to gas over the thickness of the carrier substrate in vertical direction, in the marginal region of gas passages, the melt phase in the vicinity of marginal edges is formed over the entire thickness of the carrier substrate; in other words, the surface section having the melt phase extends, at the margin of gas passages, over the entire thickness of the carrier substrate through to the opposite surface. This lateral sealing of the carrier substrate at the margin of gas passages is achieved automatically if these passages are manufactured by means, for example, of thermal operations such as laser, electron, ion, water-jet or frictional cutting.

The invention further relates to a fuel cell which has one of the carrier substrates or carrier substrate arrangements of the invention, in which a layer stack with electrochemically active layers, more particularly with electrode layers, electrolyte layers or functional layers, is arranged on the surface of the central region of the carrier substrate, and an electrolyte layer is gas-imperviously adjacent to the fluid-impervious, near-surface marginal region.

The layer stack may be applied, for example, by physical coating techniques such as physical vapour deposition (PVD), flame spraying, plasma spraying or wet-chemical techniques such as screen printing or wet powder coating—a combination of these techniques is conceivable as well—and may have additional functional layers as well as electrochemically active layers. Thus, for example, between carrier substrate and the first electrode layer, usually an anode layer, a diffusion barrier layer, made of cerium gadolinium oxide, for example, may be provided. In one preferred embodiment, for even more reliable separation of the two process gas spaces, the gas-impervious electrolyte layer may extend with its entire periphery at least over part of the fluid-impervious, near-surface marginal region, i.e. may be drawn at least over part of the gas-impervious marginal region. In order to form a fuel cell, the carrier substrate is connected gas-imperviously at the periphery to a contact plate (interconnector). An arrangement with a multiplicity of fuel cells forms a fuel cell stack or a fuel cell system.

In the text below, exemplary embodiments of the present invention are described in detail with reference to the subsequent figures.

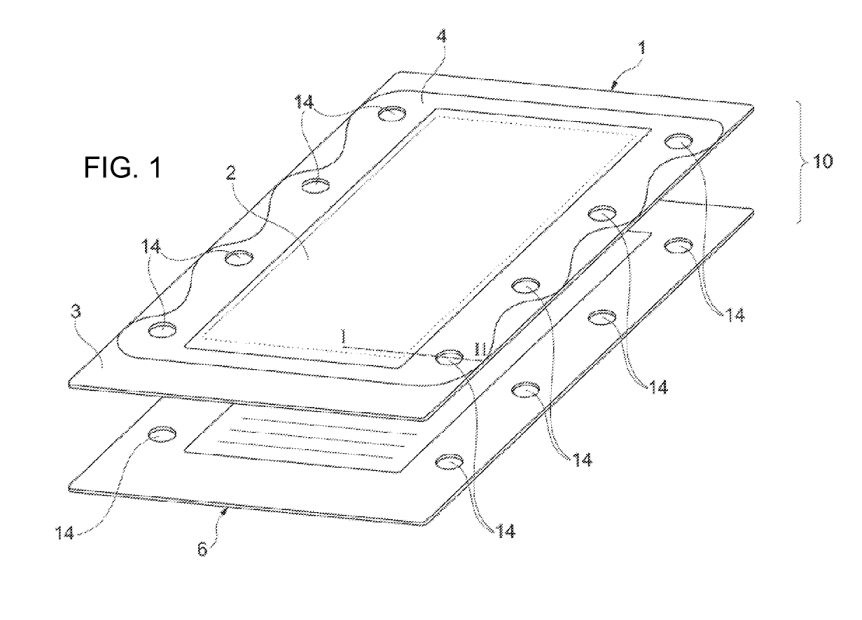

FIG. 1 shows a perspective exploded representation of a fuel cell

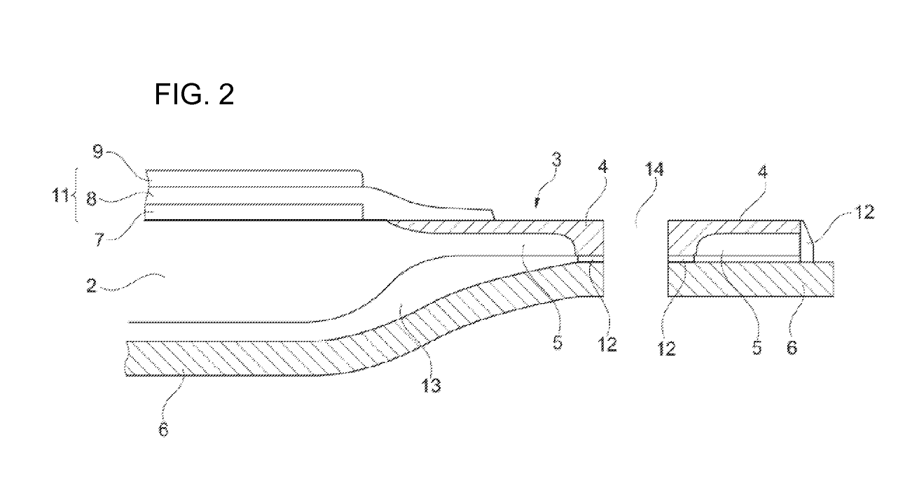

FIG. 2 shows a schematic cross section of one part of a coated carrier substrate along the line I-II in FIG. 1

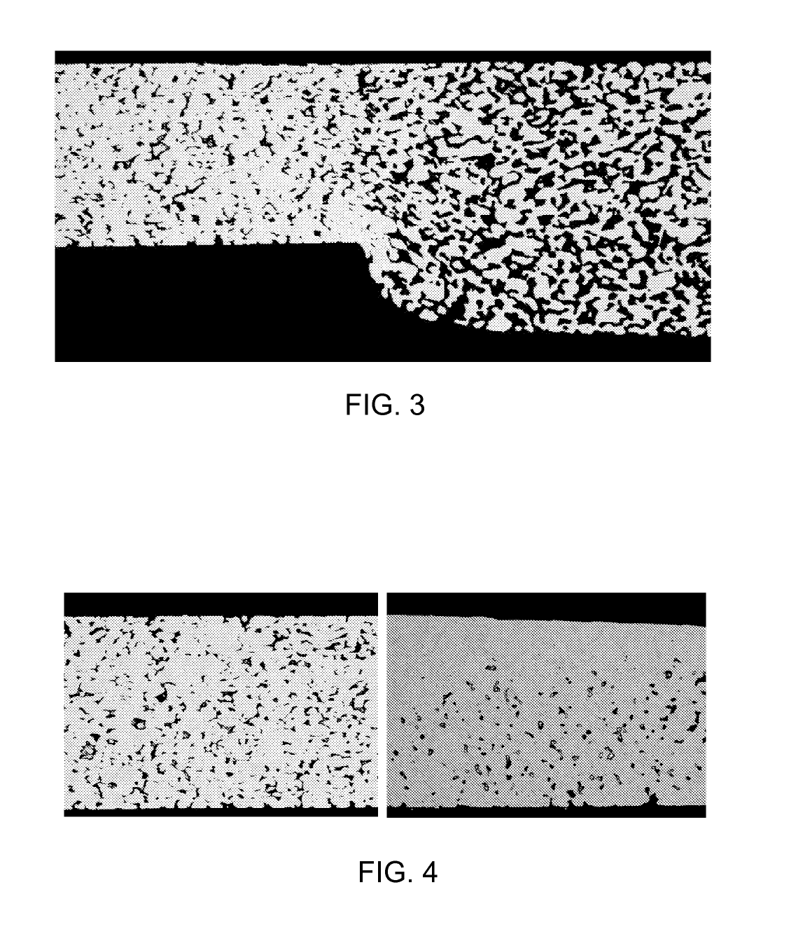

FIG. 3 shows a ground section of a detail of the porous carrier substrate with pressed marginal region

FIG. 4 shows detailed views of the pressed marginal region before (left) and after (right) a thermal surface treatment step.

FIG. 1 shows in schematic representation a fuel cell (10) consisting of a carrier substrate (1) produced by powder metallurgy and being porous and gas-permeable in a central region (2) and on which in the central region (2) a layer stack (11) with chemically active layers is arranged, and of a contact plate (6) (interconnector). One part of the carrier substrate along the line I-II in FIG. 1 is represented in cross section in FIG. 2. As set out more closely in FIG. 2, the carrier substrate (1) is compacted in the marginal region (3) bordering the central region, with the carrier substrate having been aftertreated in the marginal region on the cell-facing side, on the surface, by a surface working step which leads to superficial melting. The compacting of the marginal region is advantageous, but not mandatory. The surface section (4) having the melt phase forms a gas-impervious barrier which extends from the outer periphery of the central region, bordered by the gas-impervious electrolyte (8), to the point at which the carrier substrate is connected to the contact plate (6) in a gas-impervious manner by means of a weld seam (12). The depth of melting should be in line with the requirement for imperviosity to gas; a melting depth of between 15 μm and 60 μm has proved to be advantageous. The residual porosity of the surface section (4) having the melt phase is extremely low; the porosity of the unmelted region (5) situated below it, in the marginal region, is significantly higher than the residual porosity of the surface section having the melt phase—the porosity of the unmelted marginal region is preferably between 4 and 20%. In the central region (2) of the carrier substrate, the layer stack with chemically active layers is arranged, beginning with an anode layer (7), the gas-impervious electrolyte layer (8), which extends over part of the gas-impervious marginal region for the purpose of improved sealing, and a cathode layer (9). On two opposite sides in the marginal region, the carrier substrate has gas passages (14) which serve for the supply and removal of the fuel gas into and out of the fuel gas chamber (13), respectively. To allow the fuel gas chamber to be sealed in a gas-impervious manner, the surface section having the melting phase extends at least over a part of the marginal region that includes gas passages intended for the feeding and withdrawal of the process gases (fuel gases and oxide gases). As a result, a horizontal, gas-impervious barrier is formed which extends from the central region to the marginal edges of the gas passages intended for the feeding and withdrawal of the process gases, or to the point at which the carrier substrate is connected to the contact plate (6) by means of a weld seam (12). This welded connection may take place along the outer periphery of the carrier substrate, or else, as represented in FIG. 1, at a circumferential line at a certain distance from the outer periphery. As can be seen from FIG. 2, the margin of the gas passages is melted over the entire thickness of the carrier substrate, in order to form a gas-impervious barrier at the sides as well.

FIG. 3 and FIG. 4 show a SEM micrograph of a ground section of a porous carrier substrate with pressed marginal region, and detailed views of the pressed marginal region before (left) and after (right) a thermal surface treatment step by laser melting. A carrier substrate composed of a screened powder of an iron-chromium alloy having a particle size of less than 125 μm is produced by a conventional powder-metallurgical route. After sintering, the carrier substrate has a porosity of approximately 40% by volume. The marginal region is subsequently compacted by uniaxial pressing, to give a residual porosity in the marginal region of approximately 7-15% by volume.

A focussed laser beam with an energy per unit length of approximately 250 J/m is guided over the marginal region to be melted, and produces superficial melting of the marginal region. At the focal point of the laser, a melting zone with a depth of approximately 100 μm is formed. Following solidification, the surface section of the invention is formed, having a melt phase. The ground sections are made perpendicular to the surface of the plate-shaped carrier substrate. To produce a ground section, parts are sawn from the carrier substrate using a diamond wire saw, and these parts are fixed in an embedding composition (epoxy resin, for example) and, after curing, are ground (successively with increasingly finer grades of abrasive paper). The samples are subsequently polished using a polishing suspension, and finally are polished electrolytically.

In order to determine the porosity of the individual regions of the carrier substrate, these samples are analysed by means of SEM (scanning electron microscope) and a BSE detector (BSE: back-scattered electrons) (BSE detector or 4-quadrant annular detector).

The scanning electron microscope used was the “Ultra Pluss 55” field emission instrument from Zeiss. The SEM micrograph is evaluated quantitatively by means of stereological methods (software used: Leica QWin) within a measurement area for analysis, with care being taken to ensure that within the measurement area for analysis the detail of the part of the carrier substrate that is present is extremely homogeneous. For the porosity measurement, the proportion of pores per unit area is ascertained relative to the entire measurement area for analysis. This areal proportion corresponds at the same time to the porosity in % by volume. Pores which lie only partially within the measurement area for analysis are disregarded in the measurement process.

The settings used for the SEM micrograph were as follows:

tilt angle: 0°, acceleration voltage of 20 kV, operating distance of approximately 10 mm, and 250-times magnification (instrument specification), resulting in a horizontal image edge of approximately 600 μm. Particular value here was placed on extremely good distinctness of image.

In addition, it should be pointed out that features or steps which have been described with reference to one of the above exemplary embodiments may also be used in combination with other features or steps of other exemplary embodiments described above. Reference symbols in the claims should not be taken as implying any restriction.

1-15. (canceled)

16. A plate-shaped, porous, metallic carrier substrate produced by powder metallurgy for a metal-supported electrochemical functional device, the carrier substrate comprising:
a cell-facing side of the carrier substrate and a material of the carrier substrate;
a central region having a surface configured to receive a layer stack with electrochemically active layers on said cell-facing side of the carrier substrate;
a marginal region having a surface section on the cell-facing side of the carrier substrate, said surface section having a melt phase of the carrier substrate material; and
a region located beneath said surface section having said melt phase, at least sections of said region located beneath said surface section having a higher porosity than said surface section disposed above said sections of said region.

17. The carrier substrate according to claim 16, wherein said marginal region has a higher density and a lower porosity than said central region.

18. The carrier substrate according to claim 16, wherein said central region has an outer periphery, said marginal region has outer edges, and said surface section having said melt phase extends around said outer periphery of said central region to said outer edges of said marginal region.

19. The carrier substrate according to claim 16, wherein said surface section having said melt phase extends into the carrier substrate by at least 1 μm from a surface of the carrier substrate in a direction perpendicular to the cell-facing side of the carrier substrate.

20. The carrier substrate according to claim 16, wherein said surface section having said melt phase has a residual porosity of not more than 2%.

21. The carrier substrate according to claim 16, wherein the carrier substrate is formed in one piece.

22. The carrier substrate according to claim 16, which further comprises at least one of:
a porosity of said central region of 20% to 60% or
a porosity of said marginal region of less than 20%.

23. The carrier substrate according to claim 16, wherein the carrier substrate is formed of an Fe-Cr alloy.

24. The carrier substrate according to claim 16, wherein said marginal region has edges, the carrier substrate has a thickness and opposite surfaces, and said surface section having said melt phase extends in the vicinity of said edges of said marginal region entirely over the thickness of the carrier substrate between the opposite surfaces.

25. The carrier substrate according to claim 16, wherein said marginal region has at least one gas passage formed therein.

26. A carrier substrate configuration, comprising:
a carrier substrate according to claim 16; and
a frame device of electrically conductive material electrically contacting said carrier substrate, said frame device having at least one gas passage formed therein.

27. A fuel cell, comprising:
at least one carrier substrate according to claim 16;
said layer stack with said electrochemically active layers being disposed on said surface of said central region of said carrier substrate; and
said electrochemically active layers including an electrolyte layer overlapping said surface section having said melt phase.

28. A fuel cell, comprising:
a carrier substrate configuration according to claim 26;
said layer stack with said electrochemically active layers being disposed on said surface of said central region of said carrier substrate; and
said electrochemically active layers including an electrolyte layer overlapping said surface section having said melt phase.

29. A method for producing a carrier substrate for a metal-supported, electrochemical functional device, the method comprising the following steps:
powder-metallurgically producing a plate-shaped carrier substrate having a cell-facing side, a central region with a surface and a marginal region, the surface of the central region being configured to receive a layer stack with electrochemically active layers on the cell-facing side of the carrier substrate; and
after-treating at least a part of the marginal region, on the cell-facing side of the carrier substrate, by local, superficial melting.

30. The method according to claim 29, which further comprises, prior to the superficial melting, compacting at least part of the marginal region to provide the marginal region with a lower porosity than the central region of the carrier substrate.

31. The method according to claim 29, which further comprises applying the layer stack with the electrochemically active layers in the central region of the carrier substrate.
